(19) United States
(12) Patent Application Publication
(10) Pub. No.: US 2026/0288481 A1
(43) Pub. Date: Sep. 24, 2026

(54) IP-XACT FILE GENERATING METHOD AND APPARATUS

(71) Applicant: Samsung Electronics Co., Ltd., Suwon-si (KR)

(72) Inventors: Guanqun LI, Xian (CN); Maoxin SHEN, Xian (CN)

(73) Assignee: Samsung Electronics Co., Ltd., Suwon-si (KR)

(21) Appl. No.: 19/096,828

(22) Filed: Apr. 1, 2025

(30) Foreign Application Priority Data
Mar. 21, 2025 (CN) 2025 1 0341179.5

(51) Int. Cl. G06F 9/445; G06F 8/41

(52) U.S. Cl. CPC G06F 9/44505; G06F 8/427

(57) ABSTRACT

There is provided an IP-XACT file generating method and apparatus. The IP-XACT file generating method includes: parsing an IP-XACT-based extensible markup language (XML) schema definition (XSD) model file to acquire memory model objects; acquiring a class template file of a first language based on the memory model objects; acquiring a configuration file for configuring a format of a class structure code; acquiring a class structure code of the first language and an application programming interface (API) based on the memory model objects, the class template file of the first language, and the configuration file; and modifying a first IP-XACT file based on the class structure code of the first language and the API to generate a new IP-XACT file.

### CROSS-REFERENCE TO RELATED APPLICATIONS

This application is based on and claims priority under 35 U.S.C. § 119 to Chinese Patent Application No. 202510341179.5, filed on Mar. 21, 2025, in the Chinese National Intellectual Property Administration, the disclosure of which is incorporated by reference herein in its entirety.

### BACKGROUND

Some example embodiments relate to the field of electronic design automation (EDA) software in system on chip (SoC) design, and more particularly relate to an intellectual property exchange architecture (IP-XACT) file generating method and apparatus.

Some existing EDA software supports design automation based on IP-XACT format, including the reading, writing, extending, etc. of IP-XACT files, such as for extensible markup language (XML) files. Some existing schemes include a standard XML parsing library native to a programming language, which usually uses a document object model (DOM) parsing manner. Some schemes convert XML files into a collection of object models (usually called a DOM tree), the object model contains all information of the XML files and hierarchical relationships between respective nodes, and an application accesses and modifies the XML files through a DOM interface. Some other schemes operate in a hard-coding manner, which manually writes a class structure code of IP-XACT elements of a specified language, and realizes a design. In some schemes a component and other elements defined in an IP-XACT and various sub-elements may be referenced by them, an application instantiates related classes according to IP-XACT files, and the schemes may indirectly modifies the XML files by modifying a memory model object.

However, through the manner of DOM parsing of the standard XML parsing library, all XML document information will be stored in a memory to construct a complete document tree structure, but usually, a chip project contains a large number of XML files, which can easily cause memory overflow. Alternatively or additionally, interfaces and operations of a DOM are relatively complicated, and a user needs to or is expected to be familiar with names of elements and structural hierarchical relationships in the XML files. Even simple modifications of the XML files may be very cumbersome. Moreover, the hard-coding manner realizes a class structure of a corresponding language by completely manual hard-coding, which may be inefficient, various human errors cannot be avoided, consistency and maintainability of codes are poor, and an iteration cycle is relatively long.

### SUMMARY

Therefore, there is a desire for an IP-XACT file generating method that overcomes or at least helps to address some of the above problems.

According to some example embodiments, there is provided an intellectual property exchange architecture (IP-XACT) file generating method, including: parsing an IP-XACT-based extensible markup language (XML) schema definition (XSD) model file to acquire memory model objects; acquiring a class template file of a first language based on the memory model objects; acquiring a configuration file for configuring a format of a class structure code; acquiring a class structure code of the first language and an application programming interface (API) based on the memory model objects, the class template file of the first language, and the configuration file; and modifying a first IP-XACT file based on the class structure code of the first language and the API to generate a new IP-XACT file.

Alternatively or additionally according to some example embodiments, there is provided an intellectual property exchange architecture (IP-XACT) file generating apparatus, including: a memory model object parsing unit configured to parse an IP-XACT-based extensible markup language (XML) schema definition (XSD) model file to acquire memory model objects; a class template file acquiring unit configured to acquire a class template file of a first language based on the memory model objects; a configuration file acquiring unit configured to acquire a configuration file for configuring a format of a class structure code; a class structure code and application programming interface (API) acquiring unit configured to acquire a class structure code of the first language and an API based on the memory model objects, the class template file of the first language, and the configuration file; and an IP-XACT file generating unit configured to modify a first IP-XACT file based on the class structure code of the first language and the API to generate a new IP-XACT file.

Alternatively or additionally according to some example embodiments, there is provided an electronic device including a processor, and a memory having stored thereon computer-executable instructions that, when executed by the processor, execute the aforementioned method.

Alternatively or additionally according to some example embodiments, there is provided a computer-readable medium having stored thereon non-transitory computer-executable instructions that, when executed, execute the aforementioned method.

Alternatively or additionally, a method of fabricating a system-on-chip includes modifying an IP-XACT file according to the above methods of claim 1, and designing a system-on-chip based on the modified IP-XACT file.

In some example embodiments, the method may further include manufacturing at least one photomask based on the design.

In some example embodiments, the method may further include fabricating a semiconductor device based on the at least one photomask.

According to some example embodiments, by acquiring the class structure code of the first language and the application programming interface (API) based on the XSD model file, and further modifying the first IP-XACT file to generate a new IP-XACT file, a lackadaisical loading manner may thereby be adopted to load and modify the IP-XACT file, which may help reduce a memory load and may help eliminate or reduces the need or expectation for manual hard-coding by a user. Alternative or additionally, some example embodiments may improve user experience. Alternative or additionally, some example embodiments may also overcome or help to overcome the defects of simple and rough class structure codes generated by a general XSD code generator, and/or the need or expectation for a significant amount of manual adjustment and/or optimization. Alternatively or additionally, since the IP-XACT file is generated based on a particular language, different languages and/or languages in different versions (such as JavaScript in different versions of IEEE 1685-2009, IEEE 1685-2014, IEEE 1685-2022, etc.) may be supported with better compatibility. Alternatively or additionally, by including the formula calculation method in the API, a significant amount of business development work of the user may be saved or improved upon.

### BRIEF DESCRIPTION OF THE DRAWINGS

The above and other purposes and/or features will become more apparent from the following detailed descriptions, taken in conjunction with the accompanying drawings in which:

FIG. 1 is a flowchart illustrating an IP-XACT file generating method according some example embodiments;

FIG. 2 is a schematic diagram illustrating acquiring memory model objects according some example embodiments;

FIG. 3 is a schematic diagram illustrating acquiring a class template file of a first language according some example embodiments;

FIG. 4 is a schematic diagram illustrating a configuration file according some example embodiments;

FIG. 5 is a block diagram illustrating an IP-XACT file generating apparatus according some example embodiments; and

FIG. 6 is a flowchart illustrating a method of fabricating an SOC device according to some example embodiments.

### DETAILED DESCRIPTION

Hereinafter, various example embodiments are described with reference to the accompanying drawings, in which the same reference numerals are used to denote the same or similar elements, features, and structures. However, inventive concepts are not intended to be limited, by various example embodiments described herein, to some specific and example embodiments, but it is intended that inventive concepts cover all modifications, equivalents, and/or alternatives of example embodiments, provided they come within the scope of the appended claims and their equivalents. The terms and words used in the following description and claims are not limited to their dictionary meanings, but are merely used to enable a clear and consistent understanding of inventive concepts. Accordingly, it should be apparent to those of ordinary skill in the art that the following descriptions of various example embodiments of inventive concepts are provided for illustration purpose only and not for the purpose of limiting inventive concepts as defined by the appended claims and their equivalents.

It is to be understood that the singular forms include plural forms, unless the context clearly indicates otherwise. The terms “include”, “contain”, and “have”, used herein, indicate functions, operations, or the existence of elements of the inventive concept, but do not exclude other functions, operations, or elements.

For example, the expressions “A or B”, or “at least one of A and/or B” may indicate A and B, and A or B. For example, the expression “A or B” or “at least one of A and/or B” may indicate (1) A, (2) B, or (3) both A and B.

In various example embodiments of inventive concepts, it is intended that when a component (for example, a first component) is referred to as being “coupled” or “connected” with/to another component (for example, a second component), the component may be directly connected to the other component or may be connected through another component (for example, a third component). In contrast, when a component (for example, a first component) is referred to as being “directly coupled” or “directly connected” with/to another component (for example, a second component), another component (for example, a third component) does not exist between the component and the other component.

The expression “configured to”, used in describing various example embodiments of inventive concepts, may be used interchangeably with expressions such as “suitable for”, “having the capacity to...”, “designed to”, “adapted to”, “made to”, and “capable of”, for example, according to the situation. The term “configured to” may not necessarily indicate “specifically designed to” in terms of hardware. Instead, the expression “a device configured to” in some situations may indicate the device and another device or a part “being capable of” . For example, the expression “a processor configured to perform A, B and C” may indicate a dedicated processor (for example, an embedded processor) for performing a corresponding operation or a general purpose processor (for example, a central processing unit (CPU) and/or an application processor (AP)) for performing corresponding operations by executing at least one software program stored in a memory device.

The terms used herein are to describe certain example embodiments of inventive concepts, but are not intended to limit the scope of other embodiments. Unless otherwise indicated herein, all terms used herein, including technical or scientific terms, may have meanings the same as those generally understood by those skilled in the art. In general, terms defined in a dictionary should be considered to have the same meanings as the contextual meanings in the related art, and, unless clearly defined herein, should not be understood differently or as having excessively formal meanings. In no situation shall the terms defined in inventive concepts be intended to be interpreted to exclude some example of inventive concepts.

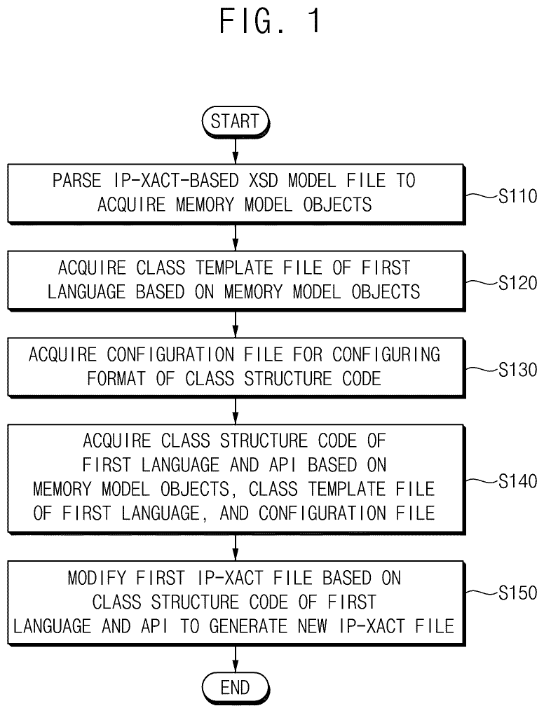

FIG. 1 is a flowchart illustrating an IP-XACT file generating method according some example embodiments. According to some example embodiments of inventive concepts, the IP-XACT file may be, may include, or may be included in, but is not limited to, an XML file.

Referring to FIG. 1, in operation S110, an IP-XACT-based XSD model file may be parsed to acquire memory model objects. Here, the IP-XACT-based XSD model file may be parsed by an XSD interpreter. The XSD scheme may define complete formal structure information including, but not limited to, element declarations (such as one or more of an element name, element type, element namespace, etc.), attribute declarations (such as one or more of attribute name, attribute type, attribute namespace, etc.), attribute usage (attribute being optional or required, etc.), element particle (such as one or more of a maximum or minimum number of an element occurred in a context), etc. According to some example embodiments, the XSD interpreter may be used to load the XSD model file and parse the respective items described above as memory model objects.

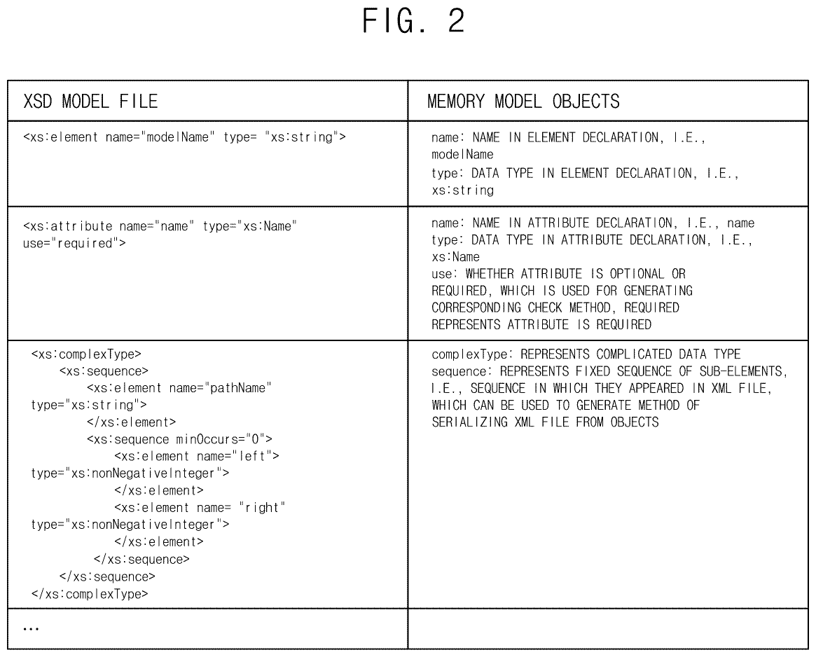

FIG. 2 is a schematic diagram illustrating acquiring memory model objects according some example embodiments. As illustrated in FIG. 2, the memory model objects in the right column may be parsed from the XSD model files in the left column.

Referring to FIGS. 1 and 2, in operation S120, a class template file of a particular first language, such as of a first specific or first predetermined language, may be acquired based on the memory model objects. Here, the first language may be determined by the user according to actual needs, for example, different languages or languages in different versions may be determined. According to some example embodiments of inventive concepts, the class template file may be, but is not limited to, a jinja2 class template file. The class template file may include, but is not limited to, one or more of a basic class structure, a variable declaration, a method framework, etc.. In some example embodiments, any text-based format (such as hypertext markup language (HTML), XML, etc.) may be generated based on the class template file. For example, the class template file includes a variable or an expression that may be replaced with an actual value when the template is actually rendered.

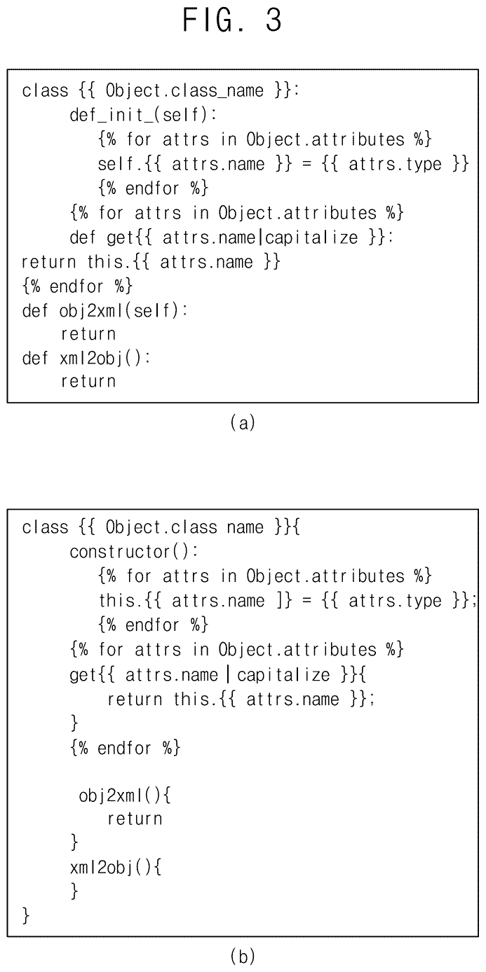

FIG. 3 is a schematic diagram illustrating acquiring a class template file of a first language, such as a first specific or first predetermined language, according some example embodiments In FIG. 3, only as an example rather than a limitation, (a) is an example class template file of a Python language, and (b) is a class template file of a JavaScript language, where {{}} represents a variable value. For example, Object may be or refer to a memory model object constructed from the XSD model file, and {%%} is a control structure.

Referring to FIGS. 1 and 3, in operation S130, a configuration file for configuring a format of a class structure code may be acquired. According to some example embodiments, the acquiring the configuration file for configuring the format of the class structure code may include acquiring the configuration file for at least one of adding, deleting and modifying a first portion, such as a first specific or first predetermined portion, in the class structure code. According to some example embodiments the configuration file may be, but is not limited to, a JSON format configuration file. For example, different projects may have their own extensions and modifications to the IP-XACT standard, and a user may customize a configuration file for generating a customized class structure code.

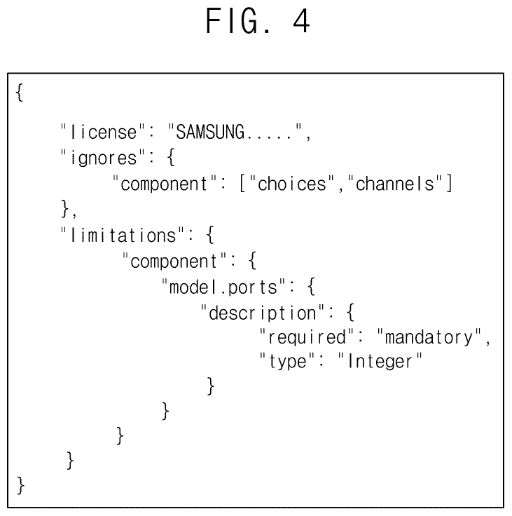

FIG. 4 is a schematic diagram illustrating a configuration file according some example embodiments. An IP-XACT file may include a component, a design and other structures. As illustrated in FIG. 4, only as an example rather than a limitation, if elements of choices and channels are not used in the component, corresponding class structure codes may be configured not to be generated and/or deleted, description of a port element may be modified from an optional attribute to a required attribute according to actual needs, and a data type may be modified from a string to an integer according to actual needs. In FIG. 4, license represents permission to generate a class structure code, ignores represents deletion of a first portion such as a first specific portion or a first predetermined portion, and limitations represent restriction, for example, the codes in FIG. 4 may represent that the generated class structure code does not include choices and channels and sub-element classes thereof, and a setDescription method of the generated Port object may also be changed according to configuration information.

Referring to FIGS. 1 and 4, in operation S140, a class structure code of the first language and an application programming interface (API) may be acquired based on the memory model objects, the class template file of the first language, and the configuration file. According to some example embodiments, the API may include at least one of a construction method, a check method, serialization and deserialization methods and a formula calculation method, wherein the construction method, the check method and the formula calculation method are used to modify the first IP-XACT file, and the serialization and deserialization methods are used to generate the new IP-XACT file. According to some example embodiments, only as an example rather than a limitation, the construction method may include get, set, etc., the check method may be used to check whether an element conforms to a standard, whether attributes are complete, whether a type conforms to a definition, etc., the serialization and deserialization methods may include obj2xml, xml2obj, etc., and the formula calculation method may include XML path calculation method, such as range of ports, addressOffset of registers, etc.

Referring to FIGS. 1 and 4, in operation S150, a first IP-XACT file such as a first specific or first predetermined IP-XACT file may be modified based on the class structure code of the first language and the API to generate a new IP-XACT file. According to some example embodiments, the modifying the first IP-XACT file based on the class structure code of the first language and the API to generate the new IP-XACT file may include: acquiring IP-XACT objects of the first IP-XACT file based on the class structure code; modifying the IP-XACT objects through the API; and generating the new IP-XACT file based on the modified IP-XACT objects. According to some example embodiments, the API may modify the IP-XACT objects using the above construction method, check method and formula calculation method, and the API may generate a new IP-XACT file using the above serialization and deserialization methods. In addition, the IP-XACT objects may be stored in a memory, and the API may modify the IP-XACT objects in the memory.

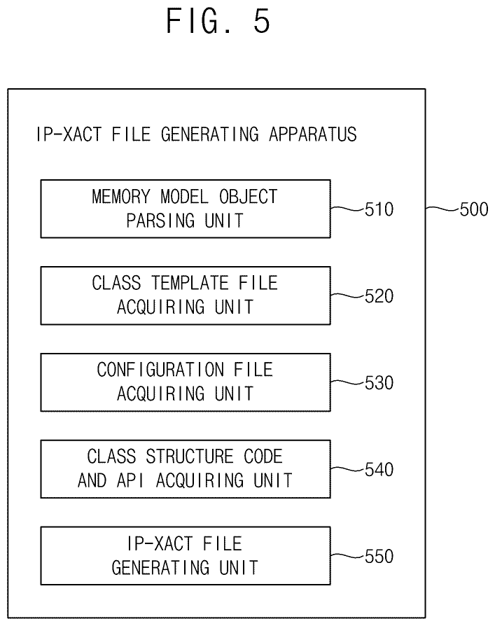

FIG. 5 is a block diagram illustrating an IP-XACT file generating apparatus according some example embodiments.

Referring to FIG. 5, an IP-XACT file generating apparatus 500 according to some example embodiments may include a memory model object parsing unit 510, a class template file acquiring unit 520, a configuration file acquiring unit 530, a class structure code and application programming interface (API) acquiring unit 540 and an IP-XACT file generating unit 550.

The memory model object parsing unit 510 may be configured to parse an IP-XACT-based extensible markup language (XML) schema definition (XSD) model file to acquire memory model objects.

The class template file acquiring unit 520 may be configured to acquire a class template file of a first language such as a first specific or first predetermined language based on the memory model objects.

The configuration file acquiring unit 530 may be configured to acquire a configuration file for configuring a format of a class structure code. According to some example embodiments, the configuration file acquiring unit 530 may further be configured to acquire the configuration file for at least one of adding, deleting and modifying a first portion in the class structure code.

The class structure code and application programming interface (API) acquiring unit 540 may be configured to acquire a class structure code of the first language and an API based on the memory model objects, the class template file of the first language, and the configuration file. According to some example embodiments, the API may include at least one of a construction method, a check method, serialization and deserialization methods and a formula calculation method, wherein the construction method, the checking method and the formula calculation method are used to modify the first IP-XACT file, and the serialization and deserialization methods are used to generate the new IP-XACT file.

The IP-XACT file generating unit 550 may be configured to modify a first IP-XACT file based on the class structure code of the first language and the API to generate the new IP-XACT file. According to some example embodiments, the IP-XACT file generating unit 550 may further be configured to acquire IP-XACT objects of the first IP-XACT file based on the class structure code and modify the IP-XACT objects through the API; and generate the new IP-XACT file based on the modified IP-XACT objects.

Any elements and/or structures and/or units illustrated or described in FIG. 5 may communicate with any other elements and/or structures and/or units illustrated in FIG. 5. Any component illustrated and/or described with reference to FIG. 5 may transfer and/or receive and/or broadcast data such as but not limited to information and/or commands to any other component illustrated and/or described with reference to FIG. 5, for example in a serial and/or a parallel fashion, over a bus such as but not limited to a wired bus and/or a wireless buss. The data may be analog and/or digital. Certain functions described with reference to one of the components illustrated in FIG. 5 may alternatively or additionally be performed by one or more other of the components illustrated in FIG. 5, and in some cases may be performed concurrently and/or at least partially concurrently. Example embodiments are not limited thereto.

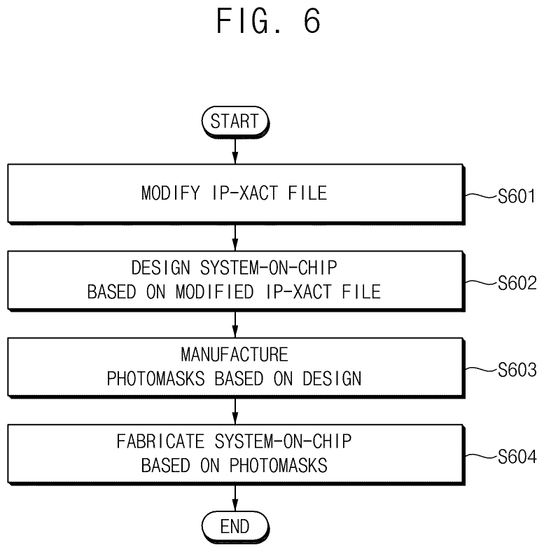

FIG. 6 is an example flowchart describing a method of fabricating a semiconductor device, according to some example embodiments.

Referring to FIG. 6, in operation S601, an IP-XACT file may be provisioned and modified. In some example embodiments, the IP-XACT file may be modified according to the methods described above.

In operation S602, a system-on-chip (SOC) may be designed, based on the modified IP-XACT file.

In operation S603, at least one photomask may be manufactured, based on the design.

In operation S604, a system-on-chip may be fabricated, based on the at least one photomasks.

According some example embodiments, there is provided a computer-readable medium having stored thereon computer-executable instructions that, when executed, execute the aforementioned method. Examples of the computer-readable medium here may include one or more of Read Only Memory (ROM), Random Access Programmable Read Only Memory (PROM), Electrically Erasable Programmable Read Only Memory (EEPROM), Random Access Memory (RAM), Dynamic Random Access Memory (DRAM), Static Random Access Memory (SRAM), Flash, Non-Volatile Memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, hard disk drive (HDD), solid state drive (SSD), card storage (such as, Multimedia Cards, Secure Digital (SD) Cards or Extreme Digital (XD) Cards), magnetic tapes, floppy disks, magneto-optical data storage devices, optical data storage devices, hard disks, solid state disks, and any other device. The any other device is configured to store a computer program and any relevant data, data files and data structures in a non-transitory manner and to provide the computer program and any relevant data, data files and data structures to a processor or computer, so that the processor or computer can execute the computer program. The computer program in the above computer-readable medium may run in an environment deployed in computer devices such as a client, a host, an agent device and a server. Alternatively or additionally, in some examples, the computer program and any relevant data, data files and data structures are distributed over networked computer systems, so that the computer program and any relevant data, data files and data structures are stored, accessed and executed in a distributed manner by one or more processors or computers.

According some example embodiments, by acquiring the class structure code of the first language and the application programming interface (API) based on the XSD model file, and further modifying the first IP-XACT file to generate a new IP-XACT file, a lackadaisical and/or more efficient loading manner may thereby be adopted to load and modify the IP-XACT file, which reduces a memory load and reduces or eliminates the need for manual hard-coding by a user, and/or improves user experience. Alternatively or additionally, some example embodiments may also overcome or help to overcome the defects of simple and rough class structure codes generated by a general XSD code generator, and the need for a significant amount of manual adjustment and improvement/optimization. Alternatively or additionally, since the IP-XACT file is generated based on a first language such as a first specific language or a first language, different languages or languages in different versions (such as JavaScript in different versions of IEEE 1685-2009, IEEE 1685-2014, IEEE 1685-2022, etc.) may be supported with better compatibility. Alternatively or additionally, by including the formula calculation method in the API, a significant amount of business development work of the user may be saved.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

Although some example embodiments have been illustrated and described with reference to specific example embodiments, it will be understood by those of ordinary skill in the art that various changes in form and detail may be made without departing from the spirit and scope of inventive concepts as defined by the claims and the equivalents thereof.

What is claimed is:

1. An intellectual property exchange architecture (IP-XACT) file generating method, comprising:
parsing an IP-XACT-based extensible markup language (XML) schema definition (XSD) model file to acquire memory model objects;
acquiring a class template file of a first language based on the memory model objects;
acquiring a configuration file for configuring a format of a class structure code;
acquiring a class structure code of the first language and an application programming interface (API) based on the memory model objects, the class template file of the first language, and the configuration file; and
modifying a first IP-XACT file based on the class structure code of the first language and the API to generate a new IP-XACT file.

2. The IP-XACT file generating method of claim 1, wherein the acquiring the configuration file for configuring the format of the class structure code comprises:
acquiring the configuration file for at least one of adding, deleting, and modifying a first portion in the class structure code.

3. The IP-XACT file generating method of claim 1, wherein
the API comprises at least one of a construction method, a check method, serialization and deserialization methods, and a formula calculation method, and
the method includes using the at least one of the construction method, the check method and the formula calculation method to modify the first IP-XACT file, and the serialization and deserialization methods to generate the new IP-XACT file.

4. The IP-XACT file generating method of claim 1, wherein
the modifying the first IP-XACT file based on the class structure code of the first language and the API to generate the new IP-XACT file comprises:
acquiring IP-XACT objects of the first IP-XACT file based on the class structure code;
modifying the IP-XACT objects through the API; and
generating the new IP-XACT file based on the modified IP-XACT objects.

5. An intellectual property exchange architecture (IP-XACT) file generating apparatus, comprising:
a memory model object parsing unit configured to parse an IP-XACT-based extensible markup language (XML) schema definition (XSD) model file to acquire memory model objects;
a class template file acquiring unit configured to acquire a class template file of a first language based on the memory model objects;
a configuration file acquiring unit configured to acquire a configuration file for configuring a format of a class structure code;
a class structure code and application programming interface (API) acquiring unit configured to acquire a class structure code of the first language and an API based on the memory model objects, the class template file of the first language, and the configuration file; and
an IP-XACT file generating unit configured to modify a first IP-XACT file based on the class structure code of the first language and the API to generate a new IP-XACT file.

6. The IP-XACT file generating apparatus of claim 5, wherein the configuration file acquiring unit is further configured to:
acquire the configuration file for at least one of adding, deleting, and modifying a first portion in the class structure code.

7. The IP-XACT file generating apparatus of claim 5, wherein
the API comprises at least one of a construction method, a check method, serialization and deserialization methods, and a formula calculation method, and
the IP-XACT file generating apparatus uses the at least one of the construction method, the check method and the formula calculation method to modify the first IP-XACT file, and the serialization and deserialization methods to generate the new IP-XACT file.

8. The IP-XACT file generating apparatus of claim 5, wherein the IP-XACT file generating unit is further configured to:
acquire IP-XACT objects of the first IP-XACT file based on the class structure code;
modify the IP-XACT objects through the API; and
generate the new IP-XACT file based on the modified IP-XACT objects.

9. An electronic device comprising a processor, and a memory having stored thereon computer-executable instructions that, when executed by the processor, cause the electronic device to execute the method of claim 1.

10. A computer-readable medium having stored thereon non-transitory computer-executable instructions that, when executed, execute the method of claim 1.

11. A method comprising:
modifying an IP-XACT file according to the method of claim 1; and
designing a system-on-chip based on the modified IP-XACT file.

12. The method of claim 11, further comprising:
manufacturing at least one photomask based on the design.

13. The method of claim 11, further comprising:
fabricating system-on-chip based on design.

14. The method of claim 1, wherein the class template file is based on Python language.

15. The method of claim 1, wherein the class template file is based on Javascript language.

16. The IP-XACT file generating apparatus of claim 5, wherein the class template file is based on Python language.

17. The IP-XACT file generating apparatus of claim 5, wherein the class template file is based on Javascript language.
